(19) United States
(12) Patent Application Publication
(10) Pub. No.: US 2014/0169520 A1
(43) Pub. Date: Jun. 19, 2014

(54) SYSTEMS AND METHODS FOR DUAL ENERGY IMAGING

(71) Applicant: MORPHO DETECTION, INC., Newark, CA (US)

(72) Inventors: David Allen Langan, Clifton Park, NY (US); Peter Michael Edic, Albany, NY (US); Colin Richard Wilson, Niskayuna, NY (US)

(73) Assignee: Morpho Detection, Inc., Newark, CA (US)

(21) Appl. No.: 13/719,538

(22) Filed: Dec. 19, 2012

(51) Int. Cl. G06T 11/00; G01N 23/04

(52) U.S. Cl. CPC G06T 11/003; G01N 23/046
USPC 378/5; 382/131

(57) ABSTRACT

A method for processing projection data is provided. The method includes acquiring projection data of an object including a high-energy projection value and a low-energy projection value for each of a plurality of measurements, adjusting, for each measurement pair, the high- and low-energy projection values until a projection value difference between the high- and low-energy projection values is within a predetermined range of acceptable projection value differences, and generating an image of the object based on the adjusted high- and low-energy projection values.

### BACKGROUND OF THE INVENTION

The embodiments described herein relate generally to X-ray computed tomography and, more particularly, to dual-energy imaging.

In at least some known computed tomography (“CT”) imaging systems, an X-ray source projects a fan-shaped or a cone-shaped beam towards an object to be imaged. The X-ray beam passes through the object, and, after being attenuated by the object, impinges upon an array of radiation detectors. Each radiation detector produces a separate electrical signal that is a measurement of the beam intensity at the detector location. During data acquisition, a gantry that includes the X-ray source and the radiation detectors rotates around the object.

In restricted areas such as airports and correctional facilities, detecting contraband (e.g., explosives, drugs, weapons, etc.) in objects is a high priority. At least some known contraband detection systems utilize CT technology to produce CT images and detect contraband in objects such as luggage, packages, containers, etc. CT volume scanners acquire a plurality of cross-sectional CT slices of an object at regular, closely spaced intervals so that the entire volume of the object is imaged. Each pixel in each CT slice therefore represents a volume, and is referred to as a voxel. The value, or CT number, of each voxel represents an approximation of the density of the material within the voxel. Specifically, each voxel represents the X-ray linear attenuation coefficient and is related to object density and effective atomic number. Many volumetric scanners employ multiple rows of detectors arranged in an array, and the object is moved continuously through the gantry while the gantry rotates. Once the object is imaged, the generated image may be analyzed to determine whether the object contains contraband.

At least some known CT systems are dual-energy CT systems, in which projection data are acquired for both high- and low-energy X-rays. Using a material decomposition process, the high- and low-energy intensity data can be decomposed or mapped to the projection data of a pair of basis material density images. However, the mapping is relatively sensitive to measurement errors. Accordingly, errors in the projection data measurements may create streak artifacts in images generated from the decomposed projection data.

### BRIEF SUMMARY OF THE INVENTION

In one aspect, a method for processing projection data is provided. The method includes acquiring projection data of an object including a high-energy projection value and a low-energy projection value for each of a plurality of measurements, adjusting, for each measurement pair, the high- and low-energy projection values until a projection value difference between the high- and low-energy projection values is within a predetermined range of acceptable projection value differences, and generating an image of the object based on the adjusted high- and low-energy projection values.

In another aspect, a processing device is provided. The processing device is configured to acquire projection data of an object including a high-energy projection value and a low-energy projection value for each of a plurality of measurements, adjust, for each measurement pair, the high- and low-energy projection values until a projection value difference between the high- and low-energy projection values is within a predetermined range of acceptable projection value differences, and generate an image of the object based on the adjusted high- and low-energy projection values.

In yet another aspect, a security scanner for imaging an object is provided. The security scanner includes an X-ray emitter configured to emit high- and low-energy X-ray beams that pass through the object, a detector array configured to acquire raw data by detecting the X-ray beams emitted by the X-ray emitter, and a processing device. The processing device is configured to calculate projection data from the raw data, the projection data including a high-energy projection value and a low-energy projection value for each of a plurality of measurements, adjust, for each measurement pair, the high- and low-energy projection values until a projection value difference between the high- and low-energy projection values is within a predetermined range of acceptable projection value differences, and generate an image of the object based on the adjusted high- and low-energy projection values.

### BRIEF DESCRIPTION OF THE DRAWINGS

FIG. 1 is a perspective view of an exemplary computed tomography system.

FIG. 2 is a perspective view of an exemplary emitter and detector array that may be used with the computed tomography system shown in FIG. 1.

FIG. 3 is a block diagram of an exemplary electronics architecture that may be used with the computed tomography system shown in FIG. 1.

FIG. 4 is a flowchart of an exemplary method for imaging an object.

FIG. 5 is a flowchart of an exemplary method for adjusting high- and low-energy projection values.

FIG. 6 is a flowchart of an exemplary method for further adjusting high- and low-energy projection values.

FIG. 7 is a flowchart of an alternative exemplary method for further adjusting high- and low-energy projection values.

FIGS. 8A and 8B are images of an object generated using a dual-energy computed tomography system.

### DETAILED DESCRIPTION OF THE INVENTION

The systems and methods described herein enable processing dual-energy projection data to reduce streak artifacts in generated images. The projection data includes a high-energy projection value and a low-energy projection value for each of a plurality of measurements. High- and low-energy projection values that appear to be erroneous are adjusted. The adjusted high- and low-energy projection values may be mapped to basis material densities, and used to generate one or more images. By adjusting the high- and low-energy projection values as described herein, streak artifacts in the generated images are mitigated, and contraband may be more easily detected.

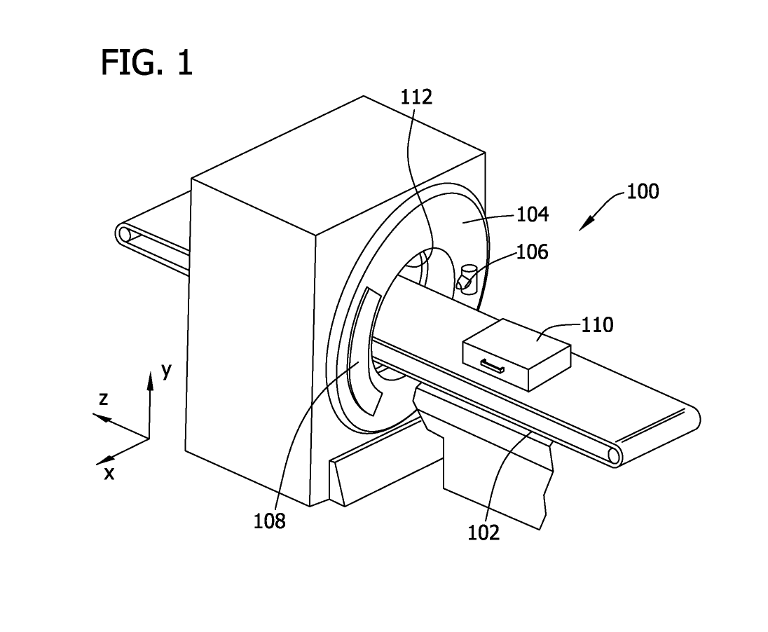

FIG. 1 is a perspective view of a computed tomography (CT) system 100. CT system 100 may be used to detect contraband, and accordingly, is also referred to herein as a security scanner. CT system 100 may be implemented in various environments. For example, CT system 100 may be utilized in a correctional facility to scan objects entering and/or leaving the facility for contraband. In another example, CT system 100 may be used at border crossings to scan packages for drugs and other smuggled items. In yet another example, CT system 100 may be used in airport security to scan luggage for contraband.

In the exemplary embodiment, CT system 100 includes a conveyor 102 and a gantry 104. Gantry 104 includes an emitter 106 (e.g., an X-ray emitter), a detector array 108, and a gantry tunnel 112. In operation, conveyor 102 moves such that when an object 110 is placed on conveyor 102, conveyor 102 moves object 110 through gantry tunnel 112 and past gantry 104. Object 110 may have any shape and/or dimensions that enable CT system 100 to function as described herein. The direction along which object 110 moves through gantry tunnel 112 is referred to herein as the z-direction, the horizontal direction orthogonal to the z-direction (lateral to conveyor belt 102) is referred to herein as the x-direction, and the vertical direction orthogonal to the x-direction and the z-direction is referred to herein as the y-direction.

To image object 110, X-ray emitter 106 and detector array 108 are rotated with gantry 104 in an x-y imaging plane that is orthogonal to the z-direction. Gantry 104 is rotated around object 110 such that an angle, or view, at which an X-ray beam intersects object 110 constantly changes. As object 110 passes through gantry 104, gantry 104 gathers X-ray intensity data acquired from detectors in detector array 108 for each view. The intensity data may be processed to generate projection data. For simplicity, the intensity data and/or processed intensity data will be referred to herein as projection data. In the exemplary embodiment, the angular difference between adjacent views is approximately 0.24 degrees. Thus, there are approximately 1500 views in a full rotation of gantry 104. Alternatively, the views may be spaced at any interval that enables CT system 100 to function as described herein.

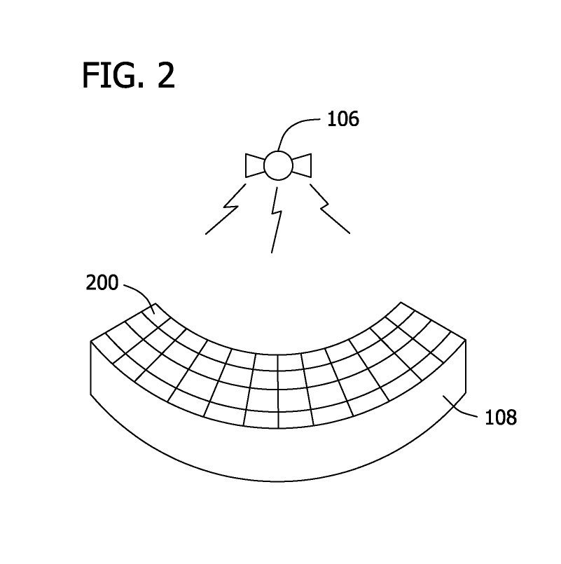

FIG. 2 is a perspective view of an exemplary emitter 106 and detector array 108 that may be used with CT system 100 (shown in FIG. 1). Emitter 106 emits X-rays that detector array 108 is configured to detect. Detector array 108 has a plurality of detector cells 200. For example, in some embodiments, detector array 108 has thousands of detector cells 200. For clarity, a relatively small number of detector cells 200 are shown in FIG. 2.

In the exemplary embodiment, CT system 100 is a dual energy CT system capable of acquiring projection data for both high-energy X-ray beams and low-energy X-ray beams. In medical applications, for example, high-energy X-ray beams are generated by an X-ray emitter having a peak voltage setting of 140 kilovolts and low-energy X-ray beams are generated by an X-ray emitter having a peak voltage setting of 80 kilovolts. In the exemplary embodiment CT system 100 acquires projection data using X-ray beams at these or any other voltages that enable CT system 100 to function as described herein. Dual-energy projection data may be obtained, for example, by repeatedly switching the voltage of emitter 106, using a filter (such as a thin layer of metal, not shown) with emitter 106 and/or detector array 108 to generate a high-energy X-ray beam, and/or using energy-resolving detectors in detector array 108.

By gathering X-ray projection data for both high- and low-energy X-ray beams, an effective atomic number and a mass density of object 110 may be calculated. Specifically, the total attenuation coefficient of a material may be expressed as in Equation 1:

μ(E)=αƒ_{c}(E)+βƒₚ(E) (1)

where μ(E) is the mass attenuation coefficient as a function of energy E, ƒ_{c}(E) is the energy-dependent Compton scattering process, ƒₚ(E) is the energy-dependent photoelectric absorption process, and α and β are characteristic constants of the material. Moreover, α is indicative of the mass density of the material, and β is indicative of the effective atomic number of the material.

When using two known basis materials, the mass attenuation coefficient for each basis material may be expressed as in Equations 2 and 3:

μ₁(E)=α₁ƒ_{c}(E)+β₁ƒₚ(E) (2)

μ₂(E)=α₂ƒ_{c}(E)+β₂ƒₚ(E) (3)

The basis materials may be, for example, water and iodine. Alternatively, the basis materials may be any suitable materials that enable CT system 100 to function as described herein. As known in the art is it possible to show that the mass attenuation for an arbitrary material can be expressed in terms of the two basis materials as in Equation 4:

μ(E)=m₁μ₁(E)+m₂μ₂(E) (4)

where m₁ and m₂ are effective densities of the basis materials.

Using CT system 100, a high-energy projection value, p_high, may be determined Similarly, a low-energy projection value, p_low, may be determined. Notably, the high- and low-energy projection values can be expressed in terms of the photoelectric and Compton absorption processes or in terms of the mass attenuation coefficient μ(E). Specifically, the high-energy projection value and low-energy projection value may be expressed as in Equations 5 and 6:

p_high=−ln({∫S_{high}(E)exp{−[αƒ_{c}(E) +βƒₚ(E)]}dE}/{∫S_{high}(E)dE}) (5)

p_low=−ln({∫S_{low}(E)exp{−[αƒ_{c}(E) +βƒₚ(E)]}dE}/{∫S_{low}(E)dE}) (6)

where S_{high} and S_{low} are the high- and low-energy spectra, respectively. Using Equation 4, the high- and low-energy projection values may be expressed in terms of the basis materials as in Equations 7 and 8:

p_high=−ln({∫S_{high}(E)exp{−[m₁μ₁(E)+m₂μ₂(E)]}dE}/{∫S_{high}(E)dE}) (7)

p_low=−ln({∫S_{low}(E)exp{−[m₁μ₁(E)+m₂μ₂(E)]}dE}/{∫S_{low}(E)dE}) (8)

Accordingly, the high- and low-energy projection values p_high and p_low may be mapped to the basis material area densities (projections of density values) m₁ and m₂. This is also referred to as a material decomposition process. The mapping between the high- and low-energy projection values and the basis material projection data is utilized to reconstruct two-dimensional or three-dimensional basis material density images of object 110. In alternate embodiments, the high-energy and low-energy projection data may be reconstructed directly to estimate energy-dependent properties of material contained within object 110.

In the exemplary embodiment, the projection data acquired using CT system 100 includes a plurality measurements each having a high-energy projection value p_high and a low-energy projection value p_low. In the exemplary embodiment, each measurement is a voxel. Alternatively, measurements may be any parameters that enable system 100 to function as described herein. For each voxel, an effective atomic number of the material within the voxel and/or a CT number representing the approximate density of the material within the voxel may be determined. Specifically, the high- and low-energy projection values are transformed into basis material projection data using non-linear material decomposition, density images of the basis materials are computed using the basis material projection data, and the density images are further processed to generate the effective atomic number distribution within object 110. A two-dimensional or three-dimensional image of object 110 may be reconstructed using any suitable method such as, for example, a backprojection method. High-energy and low-energy CT attenuation images, or one or more material basis images may also be generated from measured projection data or the decomposed projection data, respectively.

Notably, the mapping from the high- and low-energy projection values to the basis material projection data is a non-linear function and is relatively sensitive to measurement error. Specifically, errors in the high- and/or low-energy projection values can produce relatively large streak artifacts in the material basis density images. By modifying certain high- and low-energy projection values, as described in detail below, such artifacts can be mitigated. In the exemplary embodiment, the high- and low-energy projection values are adjusted to bring a projection value difference within a certain range. Alternatively, the high- and low-energy projection values could be adjusted using other suitable methods. For example, the projection values for a given measurement pair could be set as an interpolation of the projection values of neighboring measurements.

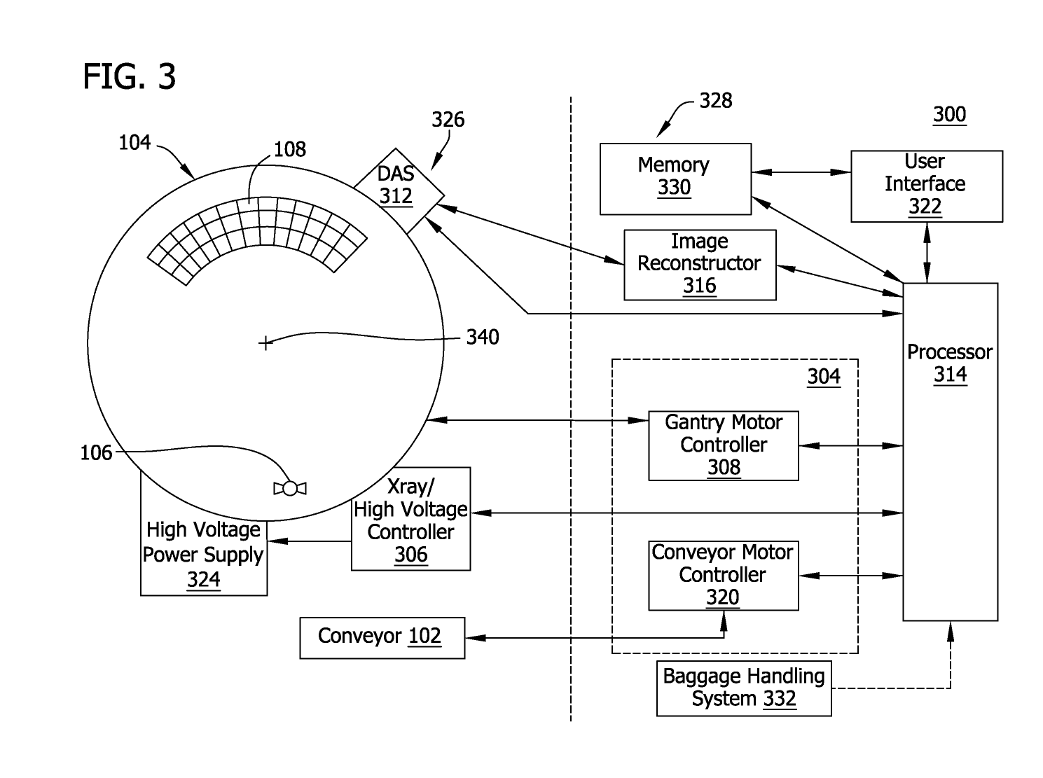

FIG. 3 depicts a block diagram of an electronics architecture 300 that may be used with CT system 100 (shown in FIG. 1). Electronics architecture 300 is separated into moving components 326 and stationary components 328. Moving components 326 include gantry 104, conveyor 102, an X-ray/high voltage controller 306, a data acquisition system (“DAS”) 312, and a high voltage power supply 324. DAS 312, X-ray/high voltage controller 306, and high voltage power supply 324 are secured to (and rotate in unison with) gantry 104 in the exemplary embodiment. Although components in FIG. 3 are described as belonging to either moving or stationary components, this description is not meant to be limiting. As such, moving or stationary components including subsets of the components listed above fall within the scope of the methods and systems described herein.

Stationary components 328 include a control mechanism 304, a processor 314, a user interface 322, memory 330, an image reconstructor 316, and a baggage handling system 332. Control mechanism 304 includes a gantry motor controller 308 and a conveyor motor controller 320. Although image reconstructor 316 and processor 314 are shown as separate components in FIG. 3, in some embodiments, image reconstructor 316 may be incorporated as part of processor 314.

Processor 314 may include one or more processing units (e.g., in a multi-core configuration). Further, processor 314 may be implemented using one or more heterogeneous processor systems in which a main processor is present with secondary processors on a single chip. As another illustrative example, processor 314 may be a symmetric multi-processor system containing multiple processors of the same type. Further, processor 314 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein.

Memory 330 is one or more devices that enable information such as executable instructions and/or other data to be stored and retrieved. Memory 330 may include one or more non-transitory computer readable media, such as, without limitation, dynamic random access memory (DRAM), static random access memory (SRAM), a solid state disk, and/or a hard disk. Memory 330 may be configured to store, without limitation, application source code, application object code, source code portions of interest, object code portions of interest, configuration data, execution events and/or any other type of data. In some embodiments, executable instructions are stored in memory 330. Processor 314 is programmed to perform one or more operations described herein. For example, processor 314 may be programmed by encoding an operation as one or more executable instructions and by providing the executable instructions in memory 330.

Gantry 104 includes emitter 106 and detector array 108. Each detector cell 200 (shown in FIG. 2) in detector array 108 produces an electrical signal that represents the intensity of an impinging X-ray beam and hence allows estimation of the attenuation of the beam as it passes through object 110. During a scan to acquire CT projection data, gantry 104 and the components mounted thereon rotate about a center of rotation 340. X-ray/high voltage controller 306 provides power to X-ray emitter 106 via the high voltage power supply 324, gantry motor controller 308 controls the rotational speed and position of gantry 104, and conveyor motor controller 320 controls the operation of conveyor 102.

DAS 312 samples analog intensity data from detector array 108 and converts the data to digital signals for subsequent processing. Accordingly, projection data is acquired for object 110 while object 110 passes through gantry tunnel 112. Processor 314 and/or image reconstructor 316 receives the projection data from DAS 312 and generates image data from the projection data. As mentioned above, the measured data by DAS 312 is actually processed to generate the projection data; however, this processing is not relevant to the methods and systems described herein. In the exemplary embodiment, the image data is generated using filtered back-projection methods. Alternatively, the image data may be generated using any suitable image reconstruction method, such as iterative image reconstruction methods, statistical reconstruction methods, or combinations thereof.

In the exemplary embodiment, the dual-energy image data includes a plurality of voxels each characterizing the composition of the object including density estimates of two known basis materials. For each voxel, an effective atomic number of the material within the voxel may be determined from the basis material density images. Alternatively, the high-energy and low-energy projection data may be reconstructed directly to compute CT number representations of object 110. Using the high-energy and low-energy projection data or basis material projection data resulting from the material decomposition process, a two-dimensional or three-dimensional image of object 110 may be reconstructed by processor 314 and/or image reconstructor 316 using any suitable methods. Additionally, the basis material density images may be further processed to generate two-dimensional and three-dimensional representations of the effective atomic number distribution within object 110.

However, as explained above, if a high-energy projection value p_high and/or a low-energy projection value p_low of a particular voxel are inconsistent (e.g., due to errors in measured intensity data), the resulting basis material density representation and/or effective atomic number of the particular voxel will also be invalid. Projection data is inconsistent when p_low is lower in magnitude than p_high which, in the absence of photon noise, electronic noise, and measurement error, is physically impossible. Because the mapping in the material decomposition process is relatively sensitive to statistical noise (both photon and electronic) and measurement errors, errors in p_high and/or p_low may result in large streak artifacts in the images representing the material basis density and/or the effective atomic number distributions. Accordingly, in the exemplary embodiment, processor 314 adjusts p_high and p_low before the non-linear decomposition process, as described in detail herein. By adjusting p_high and p_low, streak artifacts in the generated images are mitigated.

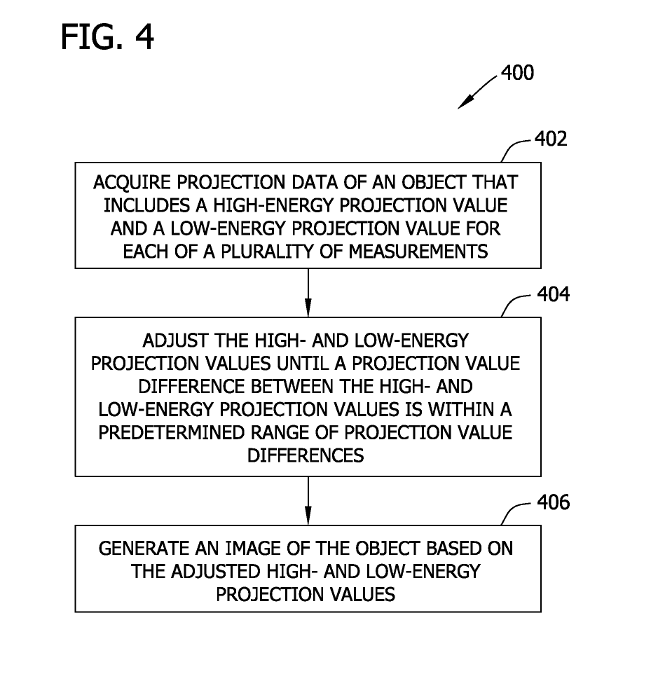

FIG. 4 is a flowchart of an exemplary method 400 for imaging an object, such as object 110 (shown in FIG. 1). Unless otherwise indicated, in the exemplary embodiment, a processing device, such as processor 314 (shown in FIG. 3), performs the steps of method 400. Projection data of the object is acquired 402. The projection data may be acquired 402 using, for example, CT system 100 (shown in FIG. 1).

The projection data includes a high-energy projection value and a low-energy projection value for each of a plurality of measurements. For each measurement pair, the high- and low-energy projection values are adjusted 404 until a projection value difference between the high- and low-energy projection values is within a predetermined range of acceptable projection value differences. Specifically, the range of projection value differences is defined from a minimum projection value difference, p_diff_min, to a maximum projection value difference, p_diff_max, assuming typical choices for materials comprising object 110 and spectra from emitter 106. Further, the projection value difference, p_diff, can be expressed as in Equation 9:

p_diff=|p_low−p_high| (9)

Once the high- and low-energy projection values are adjusted 404, an image of the object is generated 406 directly based on the adjusted high- and low-energy projection values, or an image of the object is generated using the basis material projection data generated by decomposing the high- and low-energy projection data. That is, a high-energy image, a low-energy image, and/or a material decomposition image computed from adjusted projection values may be generated.

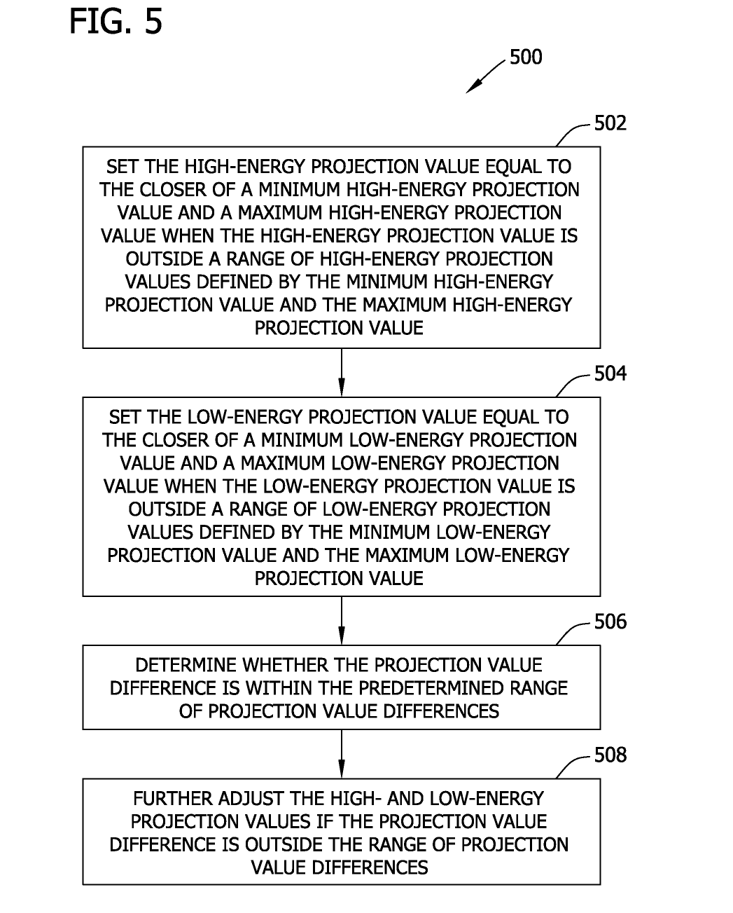

FIG. 5 is a flowchart of an exemplary method 500 for adjusting 404 the high- and low-energy projection values. Unless otherwise indicated, in the exemplary embodiment, a processing device, such as processor 314 (shown in FIG. 3), performs the steps of method 500. If the high-energy projection value is outside a range of high-energy projection values defined by a minimum high-energy projection value and a maximum high-energy projection value, the high-energy projection value is set 502 to the closer of the minimum high-energy projection value and the maximum high-energy projection value. If the high-energy projection value is within the range of high-energy projection values, the high-energy projection value is not adjusted. Notably if the high-energy projection value is outside the range, it may be indicative that the high-energy projection value is erroneous.

Specifically, the range of high-energy projection values is defined from the minimum high-energy projection value, p_high_min, to the maximum high-energy projection value, p_high_max. If p_high is less than p_high_min, p_high is set 502 equal to p_high_min. If p_high is greater than p_high_max, p_high is set 502 equal to p_high_max. If p_high is equal to p_high_min or p_high_max, or falls between p_high_min and p_high_max, p_high is not adjusted.

Similarly, if the low-energy projection value is outside a range of low-energy projection values defined by a minimum low-energy projection value and a maximum low-energy projection value, the low-energy projection value is set 504 to the closer of the minimum low-energy projection value and the maximum low-energy projection value. If the low-energy projection value is within the range of low-energy projection values, the low-energy projection value is not adjusted. Notably if the low-energy projection value is outside the range, it may be indicative that the low-energy projection value is erroneous.

Specifically, the range of low-energy projection values is defined from the minimum low-energy projection value, p_low_min, to the maximum low-energy projection value, p_low_max. If p_low is less than p_low_min, p_low is set 504 equal to p_low_min. If p_low is greater than p_low_max, p_low is set 504 equal to p_low_max. If p_low is equal to p_low_min or p_low_max, or falls between p_low_min and p_low_max, p_low is not adjusted.

After adjusting the high- and/or low-energy projection values, it is determined 506 whether the projection value difference is now within the predetermined range of projection value differences. That is, it is determined 506 whether p_diff (calculated using the adjusted values of p_low and p_high) is within the range defined by p_diff_min and p_diff_max. If p_diff is within the predetermined range of projection value differences, the adjusted high- and low-energy projection values are not further adjusted. If p_diff is still not within the predetermined range of projection value differences, p_high and p_low are further adjusted 508. Once the high- and low-energy projection values are sufficiently adjusted, an image of the object is generated directly based on the adjusted high- and low-energy projection values, or an image of the object is generated using the basis material projection data generated by decomposing the high- and low-energy projection data.

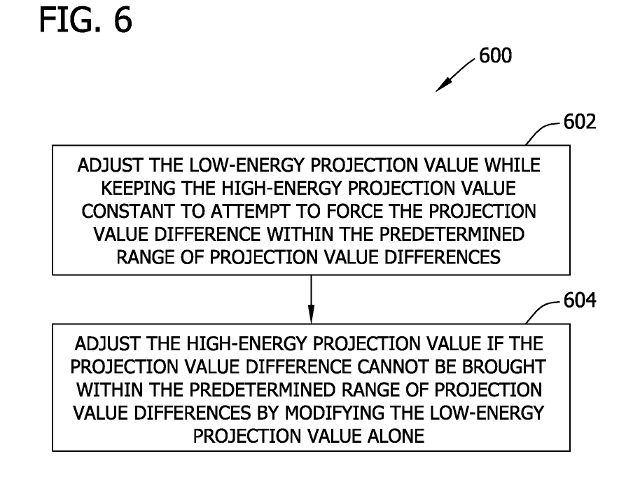

FIG. 6 is a flowchart of an exemplary method 600 for further adjusting 508 the high- and low-energy projection values. Unless otherwise indicated, in the exemplary embodiment, a processing device, such as processor 314 (shown in FIG. 3), performs the steps of method 600. While keeping p_high constant, p_low is adjusted 602 to attempt to force p_diff within the predetermined range of projection value differences. In the exemplary embodiment, although p_low is adjusted 602, p_low is still restricted to values in the range of low-energy projection values defined by p_low_min and p_low_max. If p_diff cannot be brought within the predetermined range of projection value differences by adjusting 602 p_low alone, p_high is adjusted 604 until p_diff is within the predetermined range of projection values differences. In the exemplary embodiment, although p_high is adjusted 604, p_high is still restricted to values in the range of high-energy projection values defined by p_high_min and p_high_max.

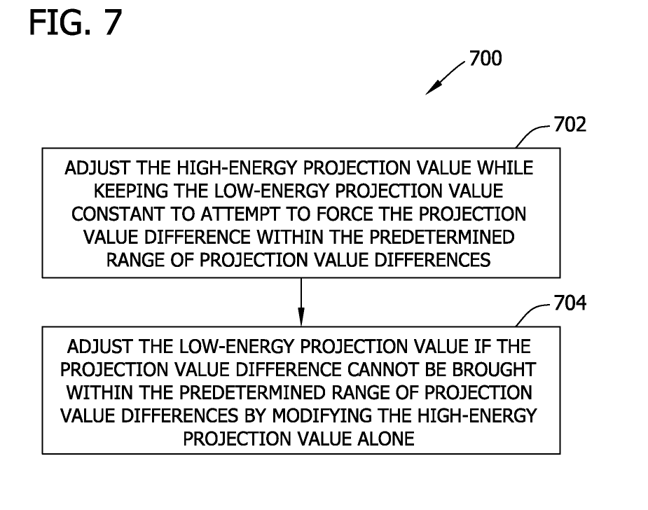

FIG. 7 is a flowchart of an alternative exemplary method 700 for further adjusting 508 the high- and low-energy projection values. Unless otherwise indicated, in the exemplary embodiment, a processing device, such as processor 314 (shown in FIG. 3), performs the steps of method 700. While keeping p_low constant, p_high is adjusted 702 to attempt to force p_diff within the predetermined range of projection value differences. In the exemplary embodiment, although p_high is adjusted 702, p_high is still restricted to values in the range of high-energy projection values defined by p_high_min and p_high_max. If p_diff cannot be forced within the predetermined range of projection value differences by adjusting 702 p_high alone, p_low is adjusted 704 until p_diff is within the predetermined range of projection values differences. In the exemplary embodiment, although p_low is adjusted 704, p_low is still restricted to values in the range of low-energy projection values defined by p_low_min and p_low_max.

Choosing whether to use method 600 or method 700 for further adjusting 508 p_high and p_low may be based on which of p_high and p_low is believed to be more accurate. For example, if p_high is believed to be more accurate, method 600 may be more advantageous than method 700, as method 600 keeps p_high constant, at least initially. On the other hand, if p_low is believed to be more accurate, method 700 may be more advantageous than method 600. In general, p_low may have a larger error due to reduced penetration of the low-energy X-rays, based on typical absorption properties of physical materials.

In the exemplary embodiment, the high-energy projection value range, the low-energy projection value range, the projection value difference are set based on typical materials that would be expected to be imaged and the specific high-energy and low-energy spectra provided by the X-ray tube.

The high-energy projection value range, the low-energy projection value range, and the projection value difference range can be thought of as defining a three-dimensional surface of valid projection values. The embodiments described herein adjust measured high- and low-energy projection values that fall outside the surface such that the adjusted values sit on the nearest edge of the surface.

As explained above, once the high- and low-energy projection values are adjusted 404 using the methods described herein, an image of the object is generated 406 based on the adjusted high- and low-energy projection values. For example, in one embodiment, a two- or three-dimensional image is generated 406 using the adjusted high- and low-energy projection values. Alternatively, one or more images may be generated 406 from the decomposition of the adjusted high- and low-energy projection values into the basis materials projection data representations. Additionally, the basis material density images may be used to generate two- and three-dimensional images of the effective atomic number distribution within the object. The generated images may be displayed, for example, on user interface 322 (shown in FIG. 3).

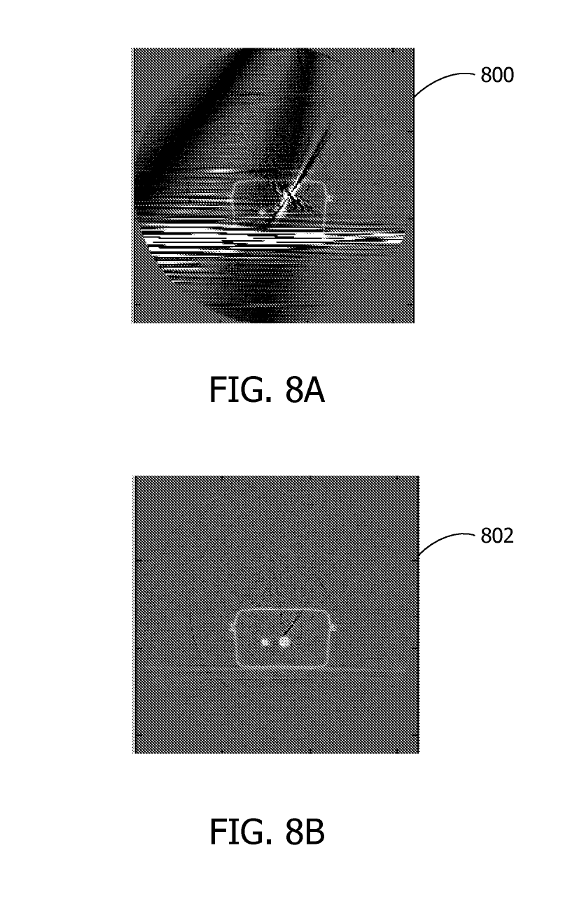

FIGS. 8A and 8B are images of an object, such as object 110, generated using a dual-energy CT system, such as CT system 100 (both shown in FIG. 1). FIG. 8A is an image 800 generated using decomposed basis material projection data generated from unadjusted high- and low-energy projection values. FIG. 8B is an image 802 generated using decomposed basis material projection data generated from adjusted high- and low-energy projection values using the methods described herein. Notably, image 800 includes a number of streak artifacts that impair visibility of the object. However, image 802 is substantially devoid of streak artifacts, making the object much clearer.

Using CT system 100 (shown in FIG. 1), generated images may be analyzed to determine whether object 110 (shown in FIG. 1) contains contraband (e.g., explosives, drugs, weapons, etc.). For example, processor 314 (shown in FIG. 3) may perform one or more image analysis operations on the image data and/or an operator may visually inspect the displayed image of object 110 for contraband. In one embodiment, processor 314 determines whether object 110 includes contraband by analyzing various representations of voxels in the image data (e.g., standard CT number, basis material density images, and/or effective atomic number images). For example, processor 314 may compare a mean CT number of the voxels to a threshold value to determine whether object 110 includes contraband. In another embodiment, processor 314 may be configured to identify predetermined shapes (e.g., sharp items indicative of blades) to determine whether object 110 includes contraband. Alternatively, processor 314 may use other suitable methods to determine whether object 110 includes contraband.

If processor 314 determines that object 110 potentially includes contraband, processor 314 may generate an alert. The alert may include any audio and/or visual indication that notifies an operator of the potential presence of contraband. For example, the alert may include at least one of a sound generated by processor 314 and/or an icon, symbol, and/or message displayed on user interface 322 (shown in FIG. 3). Upon observing the alert, the operator may take appropriate action, such as seizing object 110 and/or detaining an owner of object 110.

The embodiments described herein enable processing dual-energy image data to reduce streak artifacts in generated images. The projection data includes a high-energy projection value and a low-energy projection value for each of a plurality of measurements. High- and low-energy projection values that appear to be erroneous are adjusted. The adjusted high- and low-energy projection values may be mapped to basis material densities, and used to generate one or more images. By adjusting the high- and low-energy projection values as described herein, streak artifacts in the generated images are mitigated. Further, the resulting image data may be analyzed to detect the presence of contraband.

A technical effect of the systems and methods described herein includes at least one of: (a) acquiring projection data of an object including a high-energy projection value and a low-energy projection value for each of a plurality of measurements; (b) adjusting, for each measurement pair, the high- and low-energy projection values until a projection value difference between the high- and low-energy projection values is within a predetermined range of acceptable projection value differences; and (c) generating an image of the object based on the adjusted high- and low-energy projection values.

In some embodiments, acquiring high-energy and low-energy projection values for a plurality of measurements may include interpolating high-energy and/or low-energy projection data when both measurements are not made at each detector cell. One such example where the step of interpolation may be needed is a dual-energy system that utilizes a filter configured in a checkerboard pattern and positioned adjacent to the detector. In such an embodiment, high- and low-energy projection data may be acquired by adjacent detector cells, and interpolation is used to generate a high-energy and low-energy measurement pair suitable for processing using the techniques described herein. Accordingly, acquiring low-energy and high-energy projection data to generate a measurement pair may include interpolation of projection data.

A computer, such as those described herein, includes at least one processor or processing unit and a system memory. The computer typically has at least some form of computer readable media. By way of example and not limitation, computer readable media include computer storage media and communication media. Computer storage media include volatile and nonvolatile, removable and nonremovable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Exemplary embodiments of methods and systems for imaging an object are described above in detail. The methods and systems are not limited to the specific embodiments described herein, but rather, components of systems and/or steps of the methods may be utilized independently and separately from other components and/or steps described herein.

Accordingly, the exemplary embodiment can be implemented and utilized in connection with many other applications not specifically described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for processing projection data, said method comprising:
acquiring projection data of an object including a high-energy projection value and a low-energy projection value for each of a plurality of measurements;
adjusting, for each measurement pair, the high- and low-energy projection values until a projection value difference between the high- and low-energy projection values is within a predetermined range of acceptable projection value differences; and
generating an image of the object based on the adjusted high- and low-energy projection values.

2. A method in accordance with claim 1, wherein adjusting the high- and low-energy projection values comprises:
setting the high-energy projection value equal to the closer of a minimum high-energy projection value and a maximum high-energy projection value when the high-energy projection value is outside a range of high-energy projection values defined by the minimum high-energy projection value and the maximum high-energy projection value;
setting the low-energy projection value equal to the closer of a minimum low-energy projection value and a maximum low-energy projection value when the low-energy projection value is outside a range of low-energy projection values defined by the minimum low-energy projection value and the maximum low-energy projection value;
determining whether the projection value difference is within the predetermined range of acceptable projection value differences; and
further adjusting the high- and low-energy projection values if the projection value difference is outside the range of acceptable projection value differences.

3. A method in accordance with claim 2, wherein further adjusting the high- and low-energy projection values comprises:
adjusting the low-energy projection value while keeping the high-energy projection value constant to attempt to force the projection value difference inside the range of acceptable projection value differences; and
adjusting the high-energy projection value until the projection value difference is inside the range of acceptable projection value differences if the projection value difference cannot be brought within the range of acceptable projection value differences by adjusting only the low-energy projection value.

4. A method in accordance with claim 3, wherein adjusting the low-energy projection value comprises adjusting the low-energy projection value within the range of low-energy projection values.

5. A method in accordance with claim 2, wherein further adjusting the high-and low-energy projection values comprises:
adjusting the high-energy projection value while keeping the low-energy projection value constant to attempt to force the projection value difference inside the range of acceptable projection value differences; and
adjusting the low-energy projection value until the projection value difference is inside the range of acceptable projection value differences if the projection value difference cannot be brought within the range of acceptable projection value differences by adjusting only the high-energy projection value.

6. A method in accordance with claim 5, wherein adjusting the high-energy projection value comprises adjusting the high-energy projection value within the range of high-energy projection values.

7. A method in accordance with claim 1, wherein generating an image of the object comprises one or more of:
reconstructing a CT number image based on the adjusted high- and low-energy projection values;
reconstructing a basis material density image based on basis material projection data generated from decomposing the adjusted high- and low-energy projection values; and
reconstructing an effective atomic number image derived from the basis material density images.

8. A processing device configured to:
acquire projection data of an object including a high-energy projection value and a low-energy projection value for each of a plurality of measurements;
adjust, for each measurement pair, the high- and low-energy projection values until a projection value difference between the high- and low-energy projection values is within a predetermined range of acceptable projection value differences; and
generate an image of the object based on the adjusted high- and low-energy projection values.

9. A processing device in accordance with claim 8, wherein to adjust the high- and low-energy projection values, said processing device is configured to:
set the high-energy projection value equal to the closer of a minimum high-energy projection value and a maximum high-energy projection value when the high-energy projection value is outside a range of high-energy projection values defined by the minimum high-energy projection value and the maximum high-energy projection value;
set the low-energy projection value equal to the closer of a minimum low-energy projection value and a maximum low-energy projection value when the low-energy projection value is outside a range of low-energy projection values defined by the minimum low-energy projection value and the maximum low-energy projection value;
determine whether the projection value difference is within the predetermined range of acceptable projection value differences; and
further adjust the high- and low-energy projection values if the projection value difference is outside the range of acceptable projection value differences.

10. A processing device in accordance with claim 9, wherein to further adjust the high- and low-energy projection values, said processing device is configured to:
adjust the low-energy projection value while keeping the high-energy projection value constant to attempt to force the projection value difference inside the range of acceptable projection value differences; and
adjust the high-energy projection value until the projection value difference is inside the range of acceptable projection value differences if the projection value difference cannot be brought within the range of acceptable projection value differences by adjusting only the low-energy projection value.

11. A processing device in accordance with claim 10, wherein to adjust the low-energy projection value, said processing device is configured to adjust the low-energy projection value within the range of low-energy projection values.

12. A processing device in accordance with claim 9, wherein to further adjust the high- and low-energy projection values, said processing device is configured to:
adjust the high-energy projection value while keeping the low-energy projection value constant to attempt to force the projection value difference inside the range of acceptable projection value differences; and
adjust the low-energy projection value until the projection value difference is inside the range of acceptable projection value differences if the projection value difference cannot be brought within the range of acceptable projection value differences by adjusting only the high-energy projection value.

13. A processing device in accordance with claim 12, wherein to adjust the high-energy projection value, said processing device is configured to adjust the high-energy projection value within the range of high-energy projection values.

14. A security scanner for imaging an object, the security scanner comprising:
an X-ray emitter configured to emit high- and low-energy X-ray beams that pass through the object;
a detector array configured to acquire raw data by detecting the X-ray beams emitted by said X-ray emitter; and
a processing device configured to:
calculate projection data from the raw data, the projection data including a high-energy projection value and a low-energy projection value for each of a plurality of measurements;
adjust, for each measurement pair, the high- and low-energy projection values until a projection value difference between the high- and low-energy projection values is within a predetermined range of acceptable projection value differences; and
generate an image of the object based on the adjusted high- and low-energy projection values.

15. A security scanner in accordance with claim 14, wherein to adjust the high- and low-energy projection values, said processing device is configured to:
set the high-energy projection value equal to the closer of a minimum high-energy projection value and a maximum high-energy projection value when the high-energy projection value is outside a range of high-energy projection values defined by the minimum high-energy projection value and the maximum high-energy projection value;
set the low-energy projection value equal to the closer of a minimum low-energy projection value and a maximum low-energy projection value when the low-energy projection value is outside a range of low-energy projection values defined by the minimum low-energy projection value and the maximum low-energy projection value;
determine whether the projection value difference is within the predetermined range of acceptable projection value differences; and
further adjust the high- and low-energy projection values if the projection value difference is outside the range of acceptable projection value differences.

16. A security scanner in accordance with claim 15, wherein to further adjust the high- and low-energy projection values, said processing device is configured to:
adjust the low-energy projection value while keeping the high-energy projection value constant to attempt to force the projection value difference inside the range of acceptable projection value differences; and
adjust the high-energy projection value until the projection value difference is inside the range of acceptable projection value differences if the projection value difference cannot be brought within the range of acceptable projection value differences by adjusting only the low-energy projection value.

17. A security scanner in accordance with claim 14, wherein to generate an image, said processing device is configured to at least one of:
reconstruct a CT number image based on the adjusted high- and low-energy projection values;
reconstruct a basis material density image based on basis material projection data generated from decomposing the adjusted high- and low-energy projection values; and
reconstruct an effective atomic number image derived from the basis material density images.

18. A security scanner in accordance with claim 17, wherein said processing device is further configured to detect contraband in the object.

19. A security scanner in accordance with claim 18, wherein said processing device is further configured to generate an alert if contraband is detected in the object.

20. A security scanner in accordance with claim 14, wherein said processing device is further configured to detect contraband in the object by identifying a predetermined shape in the generated image.
